(19) United States
(12) Patent Application Publication
(10) Pub. No.: US 2012/0199002 A1
(43) Pub. Date: Aug. 9, 2012

(54) FILTER WITH ODOR SUPPRESSION LAYER

(75) Inventor: Michael A. Amann, St. Louis, MO (US)

(73) Assignee: Home Health Medical Equipment Inc., d/b/a AG Industries, St. Louis, MO (US)

(21) Appl. No.: 13/020,703

(22) Filed: Feb. 3, 2011

(51) Int. Cl. B01D 46/00

(52) U.S. Cl. 95/273; 55/486; 55/467

(57) ABSTRACT

The present invention discloses a filter having multiple layers including an odor suppressing layer for use with a plurality of different types of air flow inducing devices. One filter layer acts as a standard air filter to filter contaminants out of an air flow. Another filter layer serves as an odor suppressing layer to reduce odors in the air flow. An optional additional layer adds structural integrity to the filter while also supplying additional filtration of particulate.

### BACKGROUND OF THE INVENTION

This invention relates generally to filters and, more particularly, to various embodiments of a filter with an odor suppression layer, preferably of activated carbon, and filter assemblies for housing the same for use with air flow inducing devices utilized in oxygen concentrators and other medical devices in the health care medical equipment industry.

Continuous Positive Airway Pressure (CPAP) devices, ventilators and oxygen concentrators are commonly used in the care of respiratory patients, particularly, in the health care environment, to provide sufficient air flow and a high concentration of oxygen to the patient without having to use high pressure tanks or liquid oxygen. CPAP devices deliver a stream of compressed air to a nasal pillow which, when sealed to the user's face, produces a constant pressure on the user's airways, thereby splinting the airway to keep it open during sleep. Oxygen concentrators utilize ambient atmospheric air as their source of oxygen in conjunction with a separation system such as one or more molecular sieve beds to separate oxygen from the other gases found in the air and to provide that oxygen in concentrated form to the patient. Atmospheric air typically includes approximately 80% nitrogen and 20% oxygen. In one form of separator, nitrogen is absorbed by an absorption system and is retained therein until subsequently purged.

Oxygen concentrators, ventilators, CPAP devices and other medical devices tend to be subject to increased wear from atmospheric particles which can flow into the system, thereby decreasing the service life of the machinery, while increasing maintenance time and expense. These air flow delivery devices utilize filters to filter the air taken into the devices through their respective air intake systems. In this regard, HEPA filters are commonly used in these applications, and they are rated to remove 99.97% of the particles having a size of 0.3 μm or larger. These filters typically employ a large surface area (about 120 square inches of surface filtration area) and provide a long service life. Ambient air is drawn into either a CPAP device or an oxygen concentrator from the ambient environment. Such ambient air is generally then passed through a filter assembly to remove dust and other contaminants. In a CPAP device, the air stream is then pressurized and delivered to a user's mask. In an oxygen concentrator, the filtered air is then pressurized by a compressor for introduction into the absorption system. Once the compressed air is introduced into the absorption system, the nitrogen is selectively absorbed and released to atmosphere leaving the residual oxygen available for patient use. The absorption system is then regenerated and made ready for the next cycle. Oxygen concentrators typically produce an oxygen concentration usually in the range of 90-95% by volume.

Use of an effective filtration system for separating contaminants from any gas is important for a multitude of reasons. Properly and effectively filtering the incoming ambient air before it is pressurized for a CPAP device or compressed and introduced into the absorption system of an oxygen concentrator is likewise important because effective filtration not only improves the overall efficiency of the device, but it also improves the quality of the flow provided to the patient. Poor filtration of the incoming air also subjects the devices and associated compressors to increased wear from particles which enter the system, thereby decreasing service life while increasing maintenance.

Additionally, odors can be problematic with CPAP devices, oxygen concentrators and ventilators. The delivery of an air stream which is saturated with an unwanted odor directly to the nose or mouth of a patient is very undesirable. However, standard filters often do a poor job of removing odors from the ambient air brought into the device through the air intake system.

It is therefore desirable to provide a filter with an odor suppression layer to remove odors from the ambient air taken in by air flow inducing devices such as CPAP devices, oxygen concentrators and ventilators.

Prior art filters for use during medical procedures to clean the air have been disclosed with features such as odor suppression layers. For example, a medical filter having an activated carbon layer is disclosed in Booth U.S. Pat. No. 6,746,504 entitled Filter For Use In Medical Procedures. The device in Booth is designed to filter smoke and other gases out of the body cavity of a patient during a laparoscopic procedure. Similarly, a smoke evacuation system using an activated carbon layer is disclosed in Schultz et al. U.S. Pat. No. 7,258,712 entitled Smoke Evacuation System. The device in Schultz is designed to evacuate and filter smoke from an operating room in which a laser or cautery is utilized. Similar systems are described in Schultz et al. U.S. Pat. Nos. 6,589,316 and 6,881,236, also titled Smoke Evacuation System.

Accordingly, the present invention is directed to a filter assembly designed to suppress odors as ambient air is drawn into an air flow delivery device.

### BRIEF SUMMARY OF THE INVENTION

The present invention overcomes many of the shortcomings and limitations of the prior art devices discussed above and teaches the construction and operation of several embodiments of a filter adapted for use in a wide variety of different compressor assemblies and CPAP devices wherein air is filtered such as for use in oxygen concentrators, ventilators and other medical applications in the home care medical equipment area. In one aspect of the present invention, the filter includes two layers, the first layer being an odor suppression layer while the second layer is a standard filter layer. The standard filter layer is of the type generally known in the art for filtering bacteria, dust and other contaminants associated with air flow drawn into an air flow delivery device from ambient air. The odor suppression layer is bonded to the filter layer and is designed to reduce odors associated with the air flow. The odor suppression layer is preferably activated carbon.

In a second embodiment, the filter includes three layers, the first layer being a standard filter layer, the second layer being an odor suppression layer, and the third layer being a structural filter layer. This third layer serves as both a structural layer to add integrity to the filter as a whole, and additionally acts as an additional filtration layer. The structural filter layer helps to give the filter more substance, helping to hold it in place, while also helping to trap additional particulate. It is noted that the filter layers may be oriented in any order such as positioning the odor suppression layer before the standard filter layer, with the structural filter layer being positioned after the standard filter layer.

The layers of the present filter may be bonded together using various techniques. For example, the layers may be laminated in a breathable laminate, thereby allowing gases to penetrate the lamination for filtration. Alternatively, a mechanical pinch and heat seal technique may be used, in which case the edges of the various layers are mechanically pinched together, and are then heated to the point of bonding. In another embodiment, the layers may be needled or glued together. As an alternative, the odor suppression media may be integrated into one or more of the other filter layers, thereby impregnating such layers with odor suppressing qualities.

The above discussed filter embodiments may further be housed within a filter housing of varying shapes and sizes as needed for use in CPAP devices, oxygen concentrators, ventilators and other air flow delivery devices. Such a filter housing preferably includes an air flow inlet, and air flow outlet and a filter cavity for housing a filter.

### BRIEF DESCRIPTION OF DRAWINGS

FIG. 1A is a side elevational view of a first embodiment of the present filter having two layers constructed in accordance with the teachings of the present invention.

FIG. 1B is a side elevational view of a second embodiment of the present filter having three layers constructed in accordance with the teachings of the present invention.

FIG. 2 is an exploded side elevational view of the filter shown in FIG. 1B.

FIG. 3A is a perspective view of an exemplary filter housing.

FIG. 3B is a perspective view of another exemplary filter housing

It should be understood that the present drawings are not necessarily to scale and that the embodiments disclosed herein are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein. Like numbers utilized throughout the various Figures designate like or similar parts or structure.

### DETAILED DESCRIPTION OF THE INVENTION

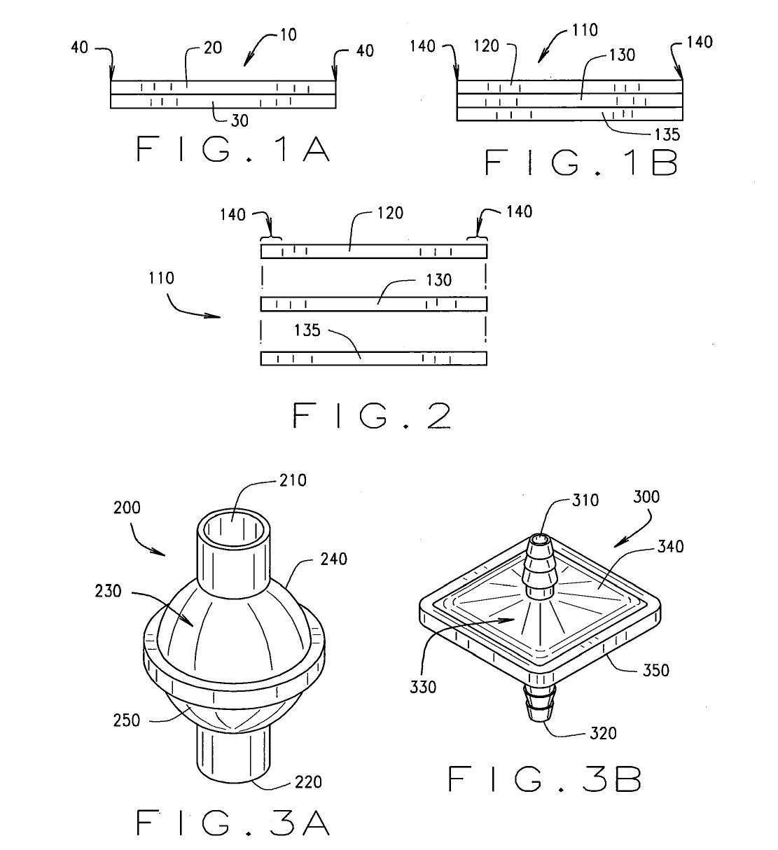

The filter 10 shown in FIG. 1A includes two layers, namely, a standard filter layer 30, and an odor suppression layer 20. The standard filter layer 30 is of the type known in the art for use in filtering bacteria, dust and other contaminants associated with air flow drawn into an air flow delivery device from ambient air. As a list of exemplary materials, the standard filter layer 30 may be composed of (a) electret ultrafine, i.e., a blend of synthetic fiber with electrostatically charged fibers, (b) polyester, (c) polyester foam, i.e., a polyester polyurethane reticulated foam, (d) borosilicate glass microfiber, i.e., a micro-fine borosilicate glass fiber with acrylic resin binder, (e) wood felt, i.e., a pressed natural wood fiber, or (f) polyester felt, i.e., a synthetic needle punched felt made from polyester fibers. Other types of filter materials suitable for filtering contaminant particles are also anticipated and envisioned based upon the particular application as would be understood by one of ordinary skill in the art.

The odor suppression layer 20 serves to help deodorize the ambient air drawn into an air flow delivery device. This layer 20 is preferably composed of an activated carbon material. As an alternative, the odor suppression material may be integrated into the standard filter layer 30 thereby impregnating the standard filter layer 30 with odor suppressing qualities.

Preferably, the air flow through the filter 10 first passes through the odor suppression layer 20 and then passes through the standard filter layer 30. Alternatively, the air flow may pass first through the standard filter layer 30, and second through the odor suppression layer 20. However, the odor suppression layer 20 is preferably positioned before the standard filter layer 30.

The filter 110 shown in FIGS. 1B and 2 includes three layers, namely, a filter layer 120, an odor suppression layer 130 and a structural filter layer 135. As in the embodiment shown in FIG. 1A, the filter layer 120 is of the type known in the art for use in filtering bacteria, dust and other contaminants associated with air flow drawn into an air flow delivery device from ambient air, and may be composed of (a) electret ultrafine, (b) polyester, (c) polyester foam, (d) borosilicate glass microfiber, (e) wood felt, or (f) polyester felt. Other types of filter materials suitable for filtering contaminant particles are also recognized and anticipated as would be understood by one of ordinary skill in the art.

The odor suppression layer 130 again serves to help deodorize the ambient air drawn into a particular air flow delivery device. As an alternative, the odor suppression material may be integrated into one or both of the filter layer 120 and structural filter layer 135, thereby impregnating such layers with odor suppressing qualities. The structural filter layer 135 may be composed of (a) polypropylene netting, i.e., a polypropylene mesh fiber, or (b) polyester. Other types of materials suitable for the structural filter layer 135 are also recognized and anticipated as would be understood by one of ordinary skill in the art.

The air flow through the filter 110 preferably passes first through the filter layer 120, then through the odor suppression layer 130, and lastly through the structural filter layer 135. Alternatively, the air flow may pass first through the odor suppression layer 130, and later pass through the filter layer 120 and structural filter layer 135.

In another alternative embodiment, the structural filter layer 135 may be positioned between the standard filter layer 120 and the odor suppression layer 130. In this arrangement, the air flow would preferably pass first through the odor suppression layer 130, then through the structural filter layer 135, and lastly through the standard filter layer 120, although the odor suppression layer may be located after the standard filter layer 120 and the structural filter layer 135. Nevertheless, the embodiment discussed above wherein the odor suppression layer 130 is sandwiched between the filter layer 120 and the structural filter layer 135 is generally preferred due to the added structural integrity of the filter 110.

The various layers of the filter 10, 110 may be bonded together using various techniques. For example, the layers may be laminated in a breathable laminate thereby allowing gases to penetrate the lamination for filtration. Alternatively, a mechanical pinch and heat seal technique may be used in which the edges 40, 140 of the various layers are mechanically pinched together, and are then heated to the point of bonding. In another embodiment, the layers may be needled or glued together.

The above discussed filter embodiments may further be housed within a filter housing of varying shapes and sizes as needed for use in CPAP devices, oxygen concentrators, ventilators and other air flow delivery devices. FIGS. 3A and 3B illustrate exemplary filter housing structures 200, 300. Each filter housing 200, 300 includes an air flow inlet 210, 310, and air flow outlet 220, 320 and a hollow filter cavity 230, 330 for housing a filter 10, 110. As shown, the filter housing 200 in FIG. 3A has a generally spherical filter cavity 230 in which a generally circular filter 10, 110 would be positioned. The filter housing 300 shown in FIG. 3B, however, has a generally square filter cavity 330 in which a generally square filter 10, 110 would be positioned. The air flow inlet 210, 310 is positioned remote from the air flow outlet 220, 320 so incoming air can flow over a substantial portion of the filter 10, 110 in a direction generally toward the air flow outlet 220, 320. It is noted that filter housings of any shape and size, and having any number of air inlets, outlets and chambers may be utilized in connection with the above described filter 10, 110 having an odor suppression layer 20, 130. Similarly, multiple filters 10, 110 may be used in a single filter housing.

The exemplary filter housings 200, 300 illustrated in FIGS. 3A and 3B include two separate housing portions, namely, a lower housing portion 250, 350 and an upper housing portion 240, 340 for ease of manufacture. As used herein, upper, lower and other position terms are used to describe the present invention as oriented in the drawings. Orientation terms, as used herein, are for orientation of the filter housings 200, 300 as oriented in FIGS. 3A and 3B. The upper housing portions 240, 340 include the air flow inlets 210, 310 for allowing ambient air to enter the filter housing 200, 300 for passage through the filter 10, 110. The air flow inlet 210, 310 may be any shape, but are shown as a circular opening in FIGS. 3A and 3B. The lower housing portion 250, 350 includes an air flow outlet 220, 320 also shown in the form of a circular opening. Housing portions 240, 340 and 250, 350 are preferably bonded or otherwise securely attached to each other to form an airtight seal at the seam using any suitable means.

Thus, there has been shown and described several embodiments of a novel filter assembly. As is evident from the foregoing description, certain aspects of the present invention are not limited by the particular details of the examples illustrated herein, and it is therefore contemplated that other modifications and applications, or equivalents thereof, will occur to those skilled in the art.

Many changes, modifications, variations and other uses and applications of the present constructions will, however, become apparent to those skilled in the art after considering this specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims which follow.

What is claimed is:

1. A filter assembly for use with an air flow inducing device comprising:
a filter layer for filtering contaminants from the air flow;
an odor suppression layer for reducing odors in the air flow, said filter and odor suppression layers forming a filter; and
a filter housing associated with the air flow inducing device having an air flow inlet, an air flow outlet and a filter cavity, said filter being positioned within said filter cavity.

2. The filter assembly of claim 1 wherein said filter layer is made of a material selected from the group consisting of electret ultrafine, polyester, polyester foam, borosilicate glass microfiber, wood felt, and polyester felt.

3. The filter assembly of claim 1 wherein said filter further includes a structural filter layer for added structural integrity and filtering.

4. The filter assembly of claim 4 wherein said structural filter layer is made of a material selected from the group consisting of polyester and polypropylene netting.

5. The filter assembly of claim 1 wherein said filter and odor suppression layers are bonded together.

6. The filter assembly of claim 5 wherein the bonding method is selected from the group consisting of lamination in a breathable laminate, a mechanical pinch and heat seal technique, needling and gluing.

7. The filter assembly of claim 3 wherein said filter, odor suppression and structural filter layers are bonded together.

8. The filter assembly of claim 7 wherein the bonding method is selected from the group consisting of lamination in a breathable laminate, a mechanical pinch and heat seal technique, needling and gluing.

9. A method of filtering air flow entering an air flow delivery device comprising the steps of:
drawing ambient air into an air inlet of the air flow delivery device to create an air flow therethrough;
passing the air flow through an odor suppression layer to reduce odors in the air flow;
passing the air flow through a filter layer to remove contaminants from the air flow; and
delivering the air flow to other components of the air flow delivery device.

10. The method of filtering air flow of claim 9 further including the step of:
passing the air flow through a structural filter layer to additionally filter the air flow and add structural integrity to said first and second filter layers.

11. An air flow delivery device comprising:
an air compressor;
a filter layer for filtering contaminants from the air flow passing through said device;
an odor suppression layer for reducing odors in the air flow, said filter and odor suppression layers comprising a filter; and
a filter housing having an air flow inlet, an air flow outlet and a filter cavity, said filter being positioned within said filter cavity, said air flow outlet passing filtered air flow to said air compressor.

12. The air flow delivery device of claim 11 wherein said filter further includes a structural filter layer for added structural integrity and for further filtering the air flow as it passes through said filter.

13. A filter for use with an air flow inducing device comprising:
a filter layer for filtering contaminants from the air flow, said filter layer being made of material selected from the group consisting of electret ultrafine, polyester, polyester foam, borosilicate glass microfiber, wood felt and polyester felt; and
an odor suppression layer for reducing odors in the air flow, said odor suppression layer including activated carbon material.

14. The filter of claim 13 further including a structural filter layer for added structural integrity and filtering, said structural filter layer being made of a material selected from the group consisting of polyester and polypropylene netting.

15. A filter for use with an air flow inducing device comprising:
a filter layer for filtering contaminants from the air flow;
an odor suppression layer for reducing air odors in the air flow; and
a structural filter layer for added structural integrity and filtering.

16. The filter of claim 15 wherein said filter layer is made of a material selected from the group consisting of electret ultrafine, polyester, polyester foam, borosilicate glass microfiber, wood felt and polyester felts, wherein said odor suppression layer is made of activated carbon material, and wherein said structural filter layer is made of a material selected from the group consisting of polyester and polypropylene netting.
